(19) United States
(12) Patent Application Publication
(10) Pub. No.: US 2024/0020783 A1
(43) Pub. Date: Jan. 18, 2024

(54) MINING ECO-ENVIRONMENT DAMAGE EVALUATION METHOD AND SYSTEM, AND STORABLE MEDIUM

(71) Applicant: Nanjing Institute of Environmental Sciences,MEE, Nanjing (CN)

(72) Inventors: Weibo MA, Nanjing (CN); Haidong LI, Nanjing (CN); Lijun ZHAO, Nanjing (CN); Nan WANG, Nanjing (CN); Shaogang LEI, Nanjing (CN); Chenwei LIU, Nanjing (CN); Longjiang ZHANG, Nanjing (CN)

(73) Assignee: Nanjing Institute of Environmental Sciences,MEE, Nanjing (CN)

(21) Appl. No.: 18/206,094

(22) Filed: Jun. 6, 2023

(30) Foreign Application Priority Data
Jul. 13, 2022 (CN) 202210819156.7

(51) Int. Cl. G06Q 50/26

(52) U.S. Cl. CPC G06Q 50/26

(57) ABSTRACT

A mining eco-environment damage evaluation method, a mining eco-environment damage evaluation system, and a storable medium are provided. The method includes: acquiring a data source to obtain an eco-environment influence factor; obtaining evaluation index information of the mining eco-environment damage; constructing a mine ecological destruction and environmental pollution loss system; establishing n loss evaluation models; and performing loss calculation on different loss evaluation models, thereby realizing damage evaluation on the mining eco-environment. The method combines actual eco-environment problems, selects key evaluation indexes emphatically, and improves evaluation accuracy based on reducing evaluation calculation amount.

### CROSS REFERENCE TO THE RELATED APPLICATIONS

This application is based upon and claims priority to Chinese Patent Application No. 202210819156.7, filed on Jul. 13, 2022, the entire contents of which are incorporated herein by reference.

### TECHNICAL FIELD

The present invention relates to the technical field of eco-environment monitoring and assessment, and in particular to a mining eco-environment damage evaluation method, a mining eco-environment damage evaluation system, and a storable medium.

### BACKGROUND

Illegal mining violently disturbs the regional eco-environment, often causing serious ecological destruction and environmental pollution, so that the integrity of the ecosystem of “mountain, water, forest, field, lake, and grass” has been destroyed, and the ecological civilization construction is seriously hindered. Due to the fact that China has a wide geographic range, various ecosystems, different scales of mine development and different mineral types, and other realistic and complex factors, there is no uniform index system to investigate environmental pollution, ecological destruction behavior, and eco-environment damage caused by mining, and to quantitatively evaluate a range and degree of eco-environment damage and corresponding restoration measures and damage amount, and meanwhile, a uniform evaluation mechanism is not provided for quantitative evaluation of ecological destruction and environmental pollution related to mineral resource development in the national supervision level.

In addition, the conventional mining eco-environment damage evaluation method emphasizes agriculture and forestry loss production loss and crop yield reduction loss, the evaluation range is not comprehensive enough, and the evaluation accuracy is influenced.

Therefore, how to provide a mining eco-environment damage evaluation method, a mining eco-environment damage evaluation system, and a storable medium is a problem that needs to be solved urgently by those skilled in the art.

### SUMMARY

In view of this, the present invention provides a mining eco-environment damage evaluation method, a mining eco-environment damage evaluation system, and a storable medium, which are used to analyze and research the current mine ecological destruction and environmental pollution damage, optimize an evaluation technical method, and establish a relatively complete evaluation system. The present invention has great significance for establishing national mine ecological compensation standards and mechanisms, providing a foundation for national green GDP accounting, providing a theoretical basis for mineral resource price forming mechanisms, and the like.

In order to achieve the above objective, the present invention provides the following technical solutions.

In one aspect, the present invention provides a mining eco-environment damage evaluation method, which includes the following steps:
S100: acquiring a data source, determining an environmental condition according to the data source, and obtaining an eco-environment influence factor according to the environmental condition;
S200: classifying and screening the data source based on the eco-environment influence factor to obtain evaluation index information of the mining eco-environment damage;
S300: constructing a mine ecological destruction and environmental pollution loss system according to the evaluation index information;
S400: establishing n loss evaluation models according to the mine ecological destruction and environmental pollution loss system; and
S500: performing loss calculation on different loss evaluation models, and performing damage evaluation on the mining eco-environment according to a loss calculation result.

Preferably, the method further includes:
S600: analyzing the damage evaluation result to obtain a probability of occurrence of various environmental damage types related to different data sources; and
S700: generating a mining eco-environment damage report according to a probability result.

Preferably, the S100 includes:
S110: acquiring the data source, and determining the environmental condition according to the data source;
S120: judging whether the environmental condition is influenced by a mineral resource development activity or not to obtain a judgment result; and
S130: obtaining the eco-environment influence factor according to the judgment result.

Preferably, the evaluation index information includes: ecological destruction system service function loss index information, agriculture and forestry production loss index information, environmental pollution and health loss index information, protective cost index information, and restoration and governance cost index information.

Preferably, the S300 includes:
S310: deriving different evaluation index information as a constraint layer, determining first native variables included in the different evaluation index information, and acquiring first derived variables associated with the first native variables, wherein the first native variables are corresponding constraint layer information;
S320: deriving the constraint layer information, and determining second derived variables associated with second native variables included in different constraint layer information, wherein the second derived variables are corresponding criterion layer information;
S330: deriving different criterion layer information, and determining third derived variables associated with third native variables included in the different criterion layer information, wherein the third derived variables are corresponding index layer information; and
S340: matching the constraint layer information, the criterion layer information, and the index layer information to generate the mine ecological destruction and environmental pollution loss system.

Preferably, the S500 includes:
S510: performing loss calculation according to the loss evaluation model to obtain a loss calculation result;
S520: analyzing physical loss measurement caused by environmental destruction according to the loss calculation result to obtain a physical loss measurement result;
S530: monetizing the physical loss measurement result to obtain a monetization result; and
S540: performing damage evaluation on the mining eco-environment according to the physical loss measurement result and the monetization result.

Preferably, the S510 includes:
S511: giving an n^{th} loss evaluation model, and setting component parameters influencing the n^{th} loss model;
S512: generating a corresponding loss value n (i, j) according to each component parameter n1 and n2 of each loss evaluation model, wherein i represents the combined serial number of n1 and n2, j represents the serial number of the n^{th} loss evaluation model, 1≤i≤m, and 1≤j≤n;
S514: calculating a maximum loss value of each loss evaluation model:

Optimal_n=Max((1:n,j));
S513: calculating an opportunity cost value of each loss evaluation model, wherein an opportunity cost value Cost(n) of the n^{th} loss evaluation model is calculated by:

Cost(n)=|Optimal_n−n(i,j)|;
S514: calculating a total opportunity cost value:

Z=Σⱼ₌₁ⁿCost(n); and
S515: obtaining a loss calculation result according to the total opportunity cost value.

In another aspect, the present invention also provides a mining eco-environment damage evaluation system, which includes:
a preprocessing module, configured to acquire a data source, determine an environmental condition according to the data source, and obtain an eco-environment influence factor according to the environmental condition;
a classification module, connected to the preprocessing module and configured to classify and screen the data source based on the eco-environment influence factor to obtain evaluation index information of the mining eco-environment damage;
a construction module, connected to the classification module and configured to construct a mine ecological destruction and environmental pollution loss system according to the evaluation index information;
a processing module, connected to the construction module and configured to establish n loss evaluation models according to the mine ecological destruction and environmental pollution loss system; and
a calculation module, connected to the processing module and configured to perform loss calculation on different loss evaluation models, and perform damage evaluation on the mining eco-environment according to a loss calculation result.

Preferably, the system further includes:
an analysis module, connected to the calculation module and configured to analyze the damage evaluation result to obtain a probability of occurrence of various environmental damage types related to different data sources; and
an output module, connected to the analysis module and configured to generate a mining eco-environment damage report according to a probability result.

In still another aspect, the present invention further provides a computer readable storage medium storing computer readable instructions, wherein the computer readable instructions, when executed by a processor, implement the steps of the mining eco-environment damage evaluation method as described above.

It can be seen from the above technical solutions that, compared with the prior art, the present invention discloses and provides a mining eco-environment damage evaluation method, a mining eco-environment damage evaluation system, and a storable medium; based on the operability of an evaluation index system and with reference to a classification method of common environmental problems and an environmental pollution cost evaluation theory and method, the present invention integrates mineral resource development life cycle into the evaluation system, focuses on five aspects of ecological destruction system service function loss, agriculture and forestry production loss caused by land use change, human health loss caused by environmental pollution, ecological restoration investment for disaster and environmental governance in the development process, and cost for restoration and governance of the caused ecological destruction and environmental pollution, and establishes a large-scale open-pit mine ecological destruction and environmental pollution loss evaluation index system based on a constraint layer, a criterion layer, and an index layer, so that the evaluation range is more comprehensive; and meanwhile, the evaluation index information of the present invention is not repeated and redundant, and the comprehensiveness and operability of index selection are considered, that is, the present invention does not evaluate all indexes one by one, but emphatically selects the key evaluation indexes according to the mine ecological destruction and the environmental pollution loss caused by different types of mining modes in combination with the actual eco-environment problem, so that the evaluation accuracy is improved based on reducing the calculation amount of evaluation.

### BRIEF DESCRIPTION OF THE DRAWINGS

In order to more clearly illustrate the technical solutions in the embodiments of the present invention or in the prior art, the drawings required to be used in the description of the embodiments or the prior art are briefly introduced below. It is obvious that the drawings in the description below are merely embodiments of the present invention, and those ordinary skilled in the art can obtain other drawings according to the drawings provided without creative efforts.

FIG. 1 is a schematic diagram of a flow of a mining eco-environment damage evaluation method according to the present invention; and

FIG. 2 is a schematic diagram of a structure of a mining eco-environment damage evaluation system according to this embodiment.

### DETAILED DESCRIPTION OF THE EMBODIMENTS

The technical solutions in the embodiments of the present invention will be clearly and completely described below with reference to the drawings in the embodiments of the present invention, and it is obvious that the described embodiments are only a part of the embodiments of the present invention, and not all of them. Based on the embodiments of the present invention, all other embodiments obtained by those ordinary skilled in the art without creative efforts shall fall within the protection scope of the present invention.

### Embodiment 1

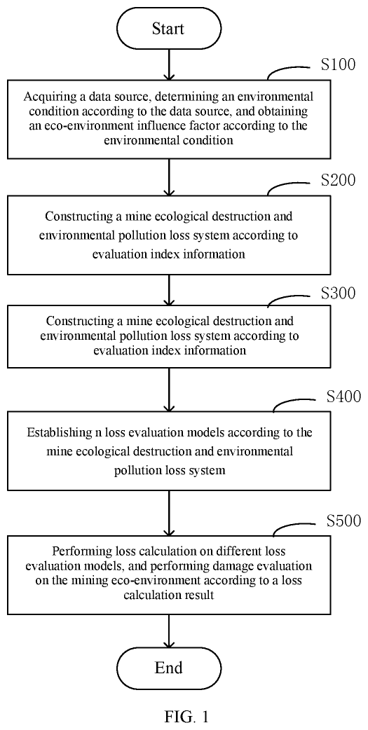

In one aspect, referring to FIG. 1, Embodiment 1 of the present invention discloses a mining eco-environment damage evaluation method, which includes the following steps:
S100: acquiring a data source, determining an environmental condition according to the data source, and obtaining an eco-environment influence factor according to the environmental condition;
S200: classifying and screening the data source based on the eco-environment influence factor to obtain evaluation index information of the mining eco-environment damage;
S300: constructing a mine ecological destruction and environmental pollution loss system according to the evaluation index information;
S400: establishing n loss evaluation models according to the mine ecological destruction and environmental pollution loss system; and
S500: performing loss calculation on different loss evaluation models, and performing damage evaluation on the mining eco-environment according to a loss calculation result.

In a specific embodiment 1, the method further includes:
S600: analyzing the damage evaluation result to obtain a probability of occurrence of various environmental damage types related to different data sources; and
S700: generating a mining eco-environment damage report according to a probability result.

In a specific embodiment 1, the S100 includes:
S110: acquiring the data source, and determining the environmental condition according to the data source;
S120: judging whether the environmental condition is influenced by a mineral resource development activity or not to obtain a judgment result; and
S130: obtaining the eco-environment influence factor according to the judgment result.

Specifically, the judging whether the environmental condition is influenced by a mineral resource development activity or not to obtain the eco-environment influence factor includes:
1) judging whether the influence of the mineral resource development activity is direct influence or indirect influence;
2) judging whether the influence is long-term influence or short-term influence;
3) judging whether the influence is reversible or unrecoverable;
4) judging whether the influence is simple influence or complex accumulated influence; and
5) judging whether an influence surface is wide or narrow.

In a specific embodiment 1, the evaluation index information includes: ecological destruction system service function loss index information, agriculture and forestry production loss index information, environmental pollution and health loss index information, protective cost index information, and restoration and governance cost index information.

Specifically, the whole mineral resource development process is divided into 3 stages according to the time sequence, namely “pre-mining”, “in-mining”, and “post-mining”, and the stages correspond to economic losses of different properties of mineral resource development ecological destruction and environmental pollution.

Classification and screening are performed on the data source based on the eco-environment influence factor, and the evaluation index information of the mining eco-environment damage is obtained according to the ecological destruction and the environmental pollution loss caused by mineral resource development with the screening rules: 1) ecological destruction system service function loss; 2) agriculture and forestry production loss caused by land use change; 3) human health loss caused by environmental pollution; 4) ecological restoration investment for disaster and environmental governance in the development process; and 5) cost for restoration and governance of the caused ecological destruction and environmental pollution.

More specifically, the ecological destruction system service function loss refers to the loss which results from long-time accumulated decline of 11 service functions of ecosystem due to changes in main carrier of the native ecosystem and damage to service function of the native ecosystem caused by the change in the land use in the mining process of mineral resource.

The agriculture and forestry production loss caused by land use change means that, in the mining process of mineral resources (“in-mining”), economic income of agriculture, forestry, cultivation, fishery cultivation, and the like on the original land is changed due to the change in land use, and the economic loss is accounted.

The human health loss caused by environmental pollution refers to the loss of human health caused by industrial “three wastes” in the mining process of mineral resources (“in-mining”).

Protective cost refers to the investment made to reduce ecological destruction and environmental pollution before mining process (“pre-mining”) and in the mining process (“in-mining”) of mineral resources, for example, mining area environmental governance cost and waste heap or tailings pond geological disaster governance.

The restoration and governance cost refers to the investment for restoration and governance of the ecological destruction and environmental pollution which has been caused after the mining is completed (post-mining), for example, investment in forest vegetation restoration for closed pit mines or abandoned mining sites, waste disposal sites, tailings ponds, and the like, investment in reclamation of damaged arable land, and cost of water pollution control.

It should be noted that there are great differences in the physical nature and economic loss accounting of ecological destruction and environmental pollution due to the differences in the understanding level of eco-environment protection among people in the mine types, mining modes, mining areas, and different economic development levels.

In a specific embodiment 1, the S300 includes:
S310: deriving different evaluation index information as a target layer, determining first native variables included in the different evaluation index information, and acquiring first derived variables associated with the first native variables, wherein the first native variables are corresponding constraint layer information;
S320: deriving the constraint layer information, and determining second derived variables associated with second native variables included in different constraint layer information, wherein the second derived variables are corresponding criterion layer information;
S330: deriving different criterion layer information, and determining third derived variables associated with third native variables included in the different criterion layer information, wherein the third derived variables are corresponding index layer information; and
S340: matching the constraint layer information, the criterion layer information, and the index layer information to generate the mine ecological destruction and environmental pollution loss system.

More specifically, the generated mine ecological destruction and environmental pollution loss system is shown in Table 1:

TABLE 1
Mine ecological destruction and environmental pollution loss system

| | Constraint | | |
|---|---|---|---|
| Target layer | layer | Criterion layer | Index layer |
| Mine | Ecological | Arable land ecosystem | Ecological function loss of |
| ecological | service | destruction (B1) | arable land (C1) |
| destruction | function loss | Grassland ecosystem | Ecological function loss of |
| and | (A1) | destruction (B2) | grassland (C2) |
| environmental | | Forest land ecosystem | Ecological function loss of |
| pollution loss | | destruction (B3) | forest land (C3) |
| evaluation | | Water ecosystem | Ecological function loss of |
| index system | | destruction (B4) | water (C4) |
| index (S) | | Secondary geological | Subsidence, collapse and ground |
| | | disaster loss (B5) | fissure loss (C5) |
| | | | Landslide and debris flow loss |
| | | | (C6) |
| | | | Ecological landscape loss (C7) |
| | Agriculture | Arable land resource | Arable land area and agricultural |
| | and forestry | destruction loss (B6) | loss (C8) |
| | production | Grassland resource | Grassland animal husbandry loss |
| | loss (A2) | destruction loss (B7) | (C9) |
| | | Forest land resource | Forest land and wood loss (C10) |
| | | destruction loss (B8) | |
| | | Water resource destruction | Wet land area and fishery loss |
| | | loss (B9) | (C11) |
| | Environmental | Atmospheric pollution loss | Acid rain and agricultural loss |
| | pollution and | (B10) | (C12) |
| | health loss | | Cleaning cost loss (C13) |
| | (A3) | | Human health loss (C14) |
| | | Water pollution loss (B11) | Sewage irrigation area loss |
| | | | (C15) |
| | | | Industrial production loss (C16) |
| | | | Human health loss (C17) |
| | | Solid and soil pollution | Land occupation and |
| | | loss (B12) | agricultural loss (C18) |
| | | | Human health loss (C19) |
| | Protective cost | Protective investment in | Ecological protection and |
| | (A4) | mining process (B13) | restoration cost (C20) |
| | | | Environmental pollution control |
| | | | cost (C21) |
| | Restoration | Post-mining restoration | Ecological protection and |
| | and | and governance cost (B14) | restoration cost (C22) |
| | governance | | Environmental pollution control |
| | cost (A5) | | cost (C23) |

The ecological service function loss (A1) is a constraint layer and consists of 5 criterion layers, namely arable land ecosystem destruction (B1), grassland ecosystem destruction (B2), forest land ecosystem destruction (B3), water ecosystem destruction (B4), and secondary geological disaster loss (B5). The constraint layer includes 7 index layers of ecological function loss of arable land (C1), ecological function loss of grassland (C2), ecological function loss of forest land (C3), ecological function loss of water (C4), subsidence, collapse and ground fissure loss (C5), landslide and debris flow loss (C6), and ecological landscape loss (C7).

The agriculture and forestry production loss (A2) is a constraint layer and consists of 4 criterion layers of arable land resource destruction loss (B6), grassland resource destruction loss (B7), forest land resource destruction loss (B8), and water resource destruction loss (B9). The constraint layer includes 4 index layers of arable land area and agricultural loss (C8), grassland animal husbandry loss (C9), forest land area and wood loss (C10), and wetland area and fishery loss (C11).

The environmental pollution and health loss (A3) is a constraint layer and consists of 3 criterion layers of atmospheric pollution loss (B10), water pollution loss (B11), and solid and soil pollution loss (B12). The constraint layer includes 8 index layers of acid rain and agricultural loss (C12), cleaning cost loss (C13), human health loss (C14), sewage irrigation area and agricultural loss (C15), industrial production loss (C16), human health loss (C17), land occupation and agricultural loss (C18), and human health loss (C19).

The protective cost (A4) is a constraint layer, and the constraint layer includes 2 indexes of ecological protection and restoration cost (C20) and environmental pollution control cost (C21).

The restoration and governance cost (A5) is a constraint layer, and the constraint layer includes 2 indexes of ecological protection and restoration cost (C22) and environmental pollution control cost (C23).

More specifically, this embodiment 1 obtains a conversion function between a native variable and a derived variable by intelligent learning based on evaluation index information, and acquires corresponding derived variable from a variable library based on the conversion function.

More specifically, by using a controlled variable method, the conversion weight of each native variable to the derived variable is determined, so that the conversion function between the two is determined.

More specifically, the variable library can be sourced from relevant data information such as the China Statistical Yearbook, the China Statistical Yearbook on Environment, and the Comprehensive Statistical Report of the Bureau of Land and Resources.

The beneficial effects from the above technical solutions are as follows: the native variables do not need to be manually configured, and the conversion function is configured for each native variable, so that derived variables are obtained; and associated variables can be directly extracted from a variable library, so that the generation efficiency of the model is improved, the condition that the configuration of the variables is omitted can be avoided, and the accuracy of evaluation of the mining eco-environment damage is further improved.

In a specific embodiment 1, the S400 of establishing n loss evaluation models according to the mine ecological destruction and environmental pollution loss system includes:
mine ecological destruction and environmental pollution loss (S) evaluation framework: S=A1+A2+A3+A4+A5.
Ecological service function loss: A1=B1+B2+B3+B4+B5, and B5=C5+C6+C7, so that A1=C1+C2+C3+C4+C5+C6+C7.
Agriculture and forestry production loss: A2=C8+C9+C10+C11.
Environmental pollution and health loss: A3=B10+B11+B12, B10=C12+C13+C14, B11=C15+C16+C17, and B12=C18+C19, so that A3=C12+C13+C14+C15+C16+C17+C18+C19.
Protective cost: A4=C20+C21.
Restoration and governance cost: A5=C22+C23.

The beneficial effects from the above technical solutions are as follows: the comprehensiveness and operability of index selection are considered, and the key direction of mine environment management is included, that is, the present invention does not evaluate all indexes one by one, but emphatically selects the key evaluation indexes according to the mine ecological destruction and the environmental pollution loss caused by different types of mining modes in combination with the actual eco-environment problem, so that the evaluation accuracy is improved based on reducing the calculation amount of evaluation.

In a specific embodiment 1, the S500 includes:
S510: performing loss calculation according to the loss evaluation model to obtain a loss calculation result;
S520: analyzing physical loss measurement caused by environmental destruction according to the loss calculation result to obtain a physical loss measurement result;
S530: monetizing the physical loss measurement result to obtain a monetization result; and
S540: performing damage evaluation on the mining eco-environment according to the physical loss measurement result and the monetization result.

In a specific embodiment 1, the S510 includes:
S511: giving an n^{th} loss evaluation model, and setting component parameters influencing the n^{th} loss model;
S512: generating a corresponding loss value n (i, j) according to each component parameter n1 and n2 of each loss evaluation model, wherein i represents the combined serial number of n1 and n2, j represents the serial number of the n^{th} loss evaluation model, 1≤i≤m, and 1≤j≤n;
S514: calculating a maximum loss value of each loss evaluation model:

Optimal_n=Max((1:n,j));
S513: calculating an opportunity cost value of each loss evaluation model, wherein an opportunity cost value Cost(n) of the n^{th} loss evaluation model is calculated by:

Cost(n)=|Optimal_n−n(i,j)|;
S514: calculating a total opportunity cost value:

Z=Σⱼ₌₁ⁿCost(n); and
S515: obtaining a loss calculation result according to the total opportunity cost value.

By using the opportunity cost method, for a multi-parameter loss evaluation model, an optimal loss calculation result in a certain sense can be obtained, and a calculation result with a small error is obtained.

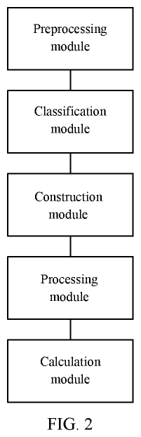

In another aspect, referring to FIG. 2, Embodiment 1 of the present invention discloses a mining eco-environment damage evaluation system, which includes:
a preprocessing module, configured to acquire a data source, determine an environmental condition according to the data source, and obtain an eco-environment influence factor according to the environmental condition;
a classification module, connected to the preprocessing module and configured to classify and screen the data source based on the eco-environment influence factor to obtain evaluation index information of the mining eco-environment damage;
a construction module, connected to the classification module and configured to construct a mine ecological destruction and environmental pollution loss system according to the evaluation index information;
a processing module, connected to the construction module and configured to establish n loss evaluation models according to the mine ecological destruction and environmental pollution loss system; and
a calculation module, connected to the processing module and configured to perform loss calculation on different loss evaluation models, and perform damage evaluation on the mining eco-environment according to a loss calculation result.

In a specific embodiment 1, the mining eco-environment damage evaluation system further includes:
an analysis module, connected to the calculation module and configured to analyze the damage evaluation result to obtain a probability of occurrence of various environmental damage types related to different data sources; and
an output module, connected to the analysis module and configured to generate a mining eco-environment damage report according to a probability result.

In still another aspect, Embodiment 1 of the present invention further provides a computer readable storage medium storing computer readable instructions, wherein the computer readable instructions, when executed by a processor, implement the steps of the mining eco-environment damage evaluation method as described above.

### Embodiment 2

Case Analysis

In this embodiment 2, Huayuan County, Hunan Province is taken as an example, and this embodiment evaluates the ecological destruction and environmental pollution loss caused by mining in Huayuan County, Hunan Province.

1. Overview of the Research Area

(1) Natural Geography

Huayuan County, a member of the Xiangxi Tujia and Miao Autonomous Prefecture of Hunan Province, is located in the western part of Hunan Province, in the middle of the Wuling Mountains, and at the junction of Hunan, Guizhou, and Chongqing. It is known as the “one place spanning three provinces” and the “southwest gateway of Hunan”. It has a subtropical monsoon mountainous humid climate. Huayuan County is rich in resources, with over 20 types of proven minerals. The proven reserve of manganese ore ranks first in Hunan Province and second in China; and the proven reserve of lead-zinc mines ranks second in Hunan Province and third in China, so that Huayuan County is known as the “Oriental Manganese Capital” and the “Hometown of Non ferrous Metals”. In 2011, it was preliminarily discovered that the prospective reserves of lead-zinc mines were 13 million metal tons, and Huayuan County is expected to become the largest lead-zinc mining base in China.

According to the remote sensing image interpretation result, the total land use area of Huayuan County is 1112.54 km². In Huayuan County, the arable land covers an area of 285.82 km², accounting for 25.69% of the total land area; the forest land covers an area of 690.17 km², accounting for 62.04% of the total land area; the grassland covers an area of 111.87 km², accounting for 10.06% of the total land area; rivers or water bodies cover an area of 3.99 km², accounting for 0.36% of the total land area; the land area for industrial, mining, and urban-rural construction is 20.27 km², accounting for 1.82% of the total land area; and the unused land covers an area of 0.42 km².

(2) Economic Development Relying Heavily on Mining

Huayuan County has been inhabited by ethnic minorities since ancient times, with a large number of impoverished people and a backward society and economy. Since the 1990s, mineral development has gradually formed a scale, and the industrial structure has rapidly transformed. In industry, the industrial and economic structure is single, and mineral resource development is the leading industry and there is no substitute industry. Huayuan County is currently in a typical industry-led economic development stage; the growth rate of the secondary industry led by mineral resources development has been in a rapid growth stage from 29.11% to 72.62% from 2000 to 2008. In 2008, the economic and financial crisis broke out, causing fluctuations in global mineral resource prices. As a resource-oriented city, the economy of Huayuan County has been greatly influenced by the continuous decline in prices of manganese, lead-zinc, and other minerals at home and abroad. Since 2009, the proportion of the secondary industry has only rebounded in 2011, while the other industries has been in a continuous decline. At the same time, the proportion of the tertiary and secondary industries has gradually increased. The correlation coefficient between the growth rate of each industry and GDP growth rate is calculated. The correlation coefficient between the secondary industry growth rate and GDP growth rate is 0.99, which is greater than 0.8, which shows that the secondary industry growth rate and the GDP are significantly correlated. The correlation coefficient between the primary industry growth rate and GDP growth rate is 0.05, and the correlation coefficient between the tertiary growth rate and the GDP growth rate is 0.67. The development and utilization of mineral resources directly promote the rapid development of the industrial economy and provide more jobs, which has led to the rapid transformation of local agricultural personnel into non-agricultural personnel, rapid urbanization, and improved economic development in impoverished ethnic minority areas.

(3) Eco-Environment Problem of Mine

The discharge of wastewater such as mine pit water and mineral processing water from mineral mining leads to problems such as ecological balance destruction of water resources, deterioration of water quality, and decrease in groundwater level; and the excavation, mining, and discharging processes have the most direct and significant impact on the surface of the lithosphere, including surface subsidence, landslide and debris flow, soil pollution, vegetation destruction, and the like.

Water resource pollution. There are 32 rivers of various sizes in Huayuan County, including the Xiongdi River and Huayuan River. The Huayuan River originates from Yizi Mountain in Chongqing and flows into Fengtan Reservoir. Its main section is located in Huayuan County, Xiangxi Autonomous Prefecture. The total length of the Huayuan River is about 187 km with a drainage area of 2797 km². During the mid-decade of vigorous mineral development, many basins of the Huayuan River experienced severe pollution. The Qingshui River at the border of the three provinces is particularly and severely polluted. The part of the water that flows through Cuicui Island in Chadong Town is even completely black, which is jokingly referred to as the “Black River” by residents, the fish and shrimp in the river are extinct, and drinking difficulty for over 0.4 million residents on both sides of the river is caused.

Soil resource pollution. Physical pollutants are generated in the process of mineral development and utilization, and the soil is highly susceptible to pollution. The particulate pollutants in the exhaust gas settle into the soil under the action of gravity, wastewater enters the soil under infiltration, and waste residue enters the soil directly through contact with the soil surface or seeps out liquid before entering. While rectifying the development of mining areas, Huayuan County encourages local small mining companies to transform and develop ecological agriculture and tourism agriculture. According to the Statistical Bulletin in 2015, the year-on-year growth of the primary and tertiary industries was 3.7% and 10.0%, respectively. The development of various industries is inseparable from a good eco-environment. After 30 years of extensive mining, the soil conditions in Huayuan County have suffered certain damage.

(4) Mine Area Restoration

Since April 2017, the Central Environmental Inspection Team starts to work, and all local mines in Huayuan County have been closed for rectification. From December 10 to Dec. 16, 2017, the research team conducted on-site investigations on the ecological restoration of 63 tailings ponds. There are a total of 98 tailings ponds in Huayuan County, of which 47, or 48%, should be restored ecologically. From a type perspective, these tailings ponds include 21 tailings ponds that have been closed for acceptance and 26 tailings ponds that are awaiting closure for governance. From a distribution perspective, these tailings ponds mainly include 5 tailings ponds in Biancheng Town, 22 tailings ponds in Huayuan Town, 13 tailings ponds in Longtan Town, 5 tailings ponds in Mao'er Township, and 2 tailings ponds in Minle Town. At present, based on the ecological restoration of tailings ponds, there are 21 tailings ponds in Huayuan County that have undergone ecological restoration (closed and accepted tailings ponds), and there are still 26 tailings ponds that need ecological restoration. However, there are many imperfections in the tailings ponds that have undergone ecological restoration, which have not been coordinated with the surrounding natural environment and landscape, and the requirements for ecological restoration standards are very low.

2. Data Source

(1) Land Use and Ecological Destruction Data

The land use data is visually interpreted through Landsat™ remote sensing images, and the ecological destruction data of the mining area is manually visually interpreted through high-resolution No. 2 remote sensing images. The remote sensing image data is preprocessed through radiometric calibration, geometric correction, and atmospheric correction. Data from 2000 and 2017 are extracted, and by comparing the two data, it can reflect the ecological destruction and restoration of mining through land use change data. The year 2000 is taken as accounting reference year.

(2) Pollution Data Source

Reference is made to Research on the Ecological Restoration of Heavy Metal Polluted Soil in Huayuan Lead and Zinc Mining Area of Xiangxi (Yang Shengxiang, 2012), Environmental Science on Heavy Metal Pollution and Its Bioavailability in the Huayuan Mining Area of Xiangxi (Yang Shengxiang et al., 2012), and Current Situation and Health Risk Evaluation of Heavy Metal Pollution in Vegetables in the Huayuan Mining Area of Xiangxi (Yang Shengxiang et al., 2012).

(3) Protective Cost Data Source

The Comprehensive Statistical Report of the Bureau of Land and Resources of Huayuan County (2011-2017), the Statistical Bulletin on National Economic and Social Development of Huayuan County (2011-2017), the Supplementary Quota Standards for Land Development and Consolidation Projects in Hunan Province (Trial), and the Supplementary Quota Standards for Land Development and Consolidation Projects in Hunan Province (Trial).

(4) Restoration and Governance Cost Data Source

Decomposition Plan for Mining Consolidation and Integration Tasks in Huayuan County (2019), Three-year Action Plan for the Battle against Pollution in Xiangxi Autonomous Prefecture (2018-2020), Supplementary Quota Standards for Land Development and Consolidation Projects in Hunan Province (Trial), and Supplementary Quota Standards for Land Development and Consolidation Projects in Hunan Province (Trial).

3. Land Damage Statistics

(1) Remote Sensing Image Interpretation

The scale of coal mining in Huayuan County reached its peak around 2010, and the land damage area also reached its peak. However, due to illegal and disorderly development and disordered management, several mining accidents occurred, and then the local government strengthened environmental regulation of mines, integrated resources for green mining, and issued several mining management measures and land regulation implementation plans (in 2012, some mining enterprises in Huayuan County were commended and recognized by the former Ministry of Land and Resources (Notice of the Ministry of Land and Resources on Praising the Second Batch of Advanced Mines for the Development and Integration of National Mineral Resources)). By 2017, the area of the governed mines had reached 158.52 ha compared to 2010.

According to the remote sensing image interpretation result, in 2000, the total area of land damage caused by mining in Huayuan County reached 837.41 ha, and however rapidly increased to 6.95 ha in 2010, and the area of land damage reached 25.95 ha/a. Among them, the land damage in tailings dams was the most significant. In 2017, the area of land damage in the mining area of Huayuan County had significantly decreased compared to 2010, achieving a decrease rate of 0.14 ha/a. The most significant types of land damage are open-pit mining sites and industrial land.

There are a total of 8 townships in Huayuan County involved in mineral resource development, among which Longtan Town, Mao'er Township, and Tuanjie Town caused the most severe land damage due to mineral resource development, and specifically caused 208.06 ha, 79.88 ha, and 340.58 ha of land damage in 2000, respectively. After the mining environment regulation in 2010, a total of three townships achieved a reduction in land damage area compared to 2000 in 2017, namely Huayuan Town, Paiwu Township, and Tuanjie Town. Among them, Tuanjie Town showed the most significant decrease in land damage compared to 2000, reaching 221.76 ha.

(2) Land Damage Area Analysis

In order to calculate the loss of the ecosystem function caused by mineral resource development and the loss caused by agriculture and forestry production, the change in the land use type caused by mineral resource development in Huayuan County from 2000 to 2017 is counted. It can be seen that the biggest loss in land area from 2000 to 2017 was caused by changes in land use types caused by tailings dams, with the most significant changes in forest land and arable land. The lost area of arable land was 199.03 ha, and the increased area of forest land was 78.86 ha. Meanwhile, compared to 2000, by 2017, Huayuan County had achieved a total of 233.27 ha of mining area for environmental regulation.

4. Loss Evaluation

Based on the characteristics of typical mining areas, appropriate evaluation index items are selected from the aforementioned mine eco-environment loss evaluation index system. The economic loss caused by ecological destruction and environmental pollution of the mine in Huayuan County from 2000 to 2017 is calculated according to the related index calculation method and the data collection condition.

(1) Ecological Service Function Loss

In terms of ecological service loss, firstly, the destruction areas of different types of ecosystems are calculated on the assumption that the destroyed ecosystems completely lose ecological service value; ecological service value loss is estimated by using the ecological service value quantity of each type of ecosystem in the unit area; and finally, the lost ecological service value is corrected based on biomass factors of different provinces and cities in China.

The ecological service value equivalent factor (hereinafter referred to as standard equivalent) of 1 standard unit ecosystem refers to the economic value of the annual natural food yield of farmland with the national average yield of 1 hm², the equivalent is taken as a reference, expert knowledge is combined, equivalent factors of other ecosystem services can be determined, and the function of the equivalent factors is to characterize and quantify potential contribution capacities of different types of ecosystems to the ecological service function. In practical application, particularly on a regional scale, it is very difficult to eliminate the interference of human factors so as to accurately measure the economic value of the grain yield which can be provided under the natural condition of a farmland ecosystem. This research takes the net profit of grain production of a unit area farmland ecosystem as the ecosystem service value quantity of 1 standard equivalent factor. The grain yield value of the farmland ecosystem is mainly calculated according to main products of rice, wheat and corn. The calculation formula is as follows:

D=Sr×Fr+Sw×Fw+Sc×Fc

In the formula: D represents the ecosystem service value quantity (yuan/hm²) of 1 standard equivalent factor; Sr, Sw, and Sc represent the percentage (%) of the sowing area of rice, wheat and corn to the total sowing area of the three crops in 2010; Fr, Fw, and Fc represent the average net profit per unit area of rice, wheat, and corn in China in 2010 (yuan/hm²). According to the China Statistical Yearbook 2011, National Compilation of Agricultural Product Cost Benefit Data 2011, and the formula, the D value is 3406.5 yuan/hm².

The forest ecological function loss is as follows: area loss (hm²)×ecosystem service value per unit area (yuan/(hm²·a))×fixed number of years (a).

The arable land ecological function loss is as follows: area loss (hm²)×ecosystem service value per unit area (yuan/(hm²·a))×fixed number of years (a).

The relevant data sources can be on-site investigations, remote sensing image interpretation [19], land use change data, and the like.

The achievement reference method is used to determine that the ecosystem service value of the forest (mixed forest of evergreen conifers and deciduous trees) in this study area is 78700 yuan/ha, the ecosystem service value of the farmland (paddy field) is 13300 yuan/(ha a), the ecosystem service value of the water body is 427900 yuan/(ha a), and the ecosystem service value of the grassland (shrub grassland) is 67100 yuan/(ha a). From 2000 to 2017, the total forest area increased by 78.86 ha, farmland area decreased by 199.03 ha, grassland area decreased by 5.3 ha, and water area decreased by 0.05 ha, resulting in a loss value of 54.2114 million yuan in forest land and arable land ecosystems during the 17 years.

(2) Agriculture and Forestry Production Loss

The reduction loss of the arable land area in agriculture and forestry production loss is mainly considered, and the arable land area loss caused by mining in Huayuan County from 2000 to 2017 is mainly considered. According to the Statistical Yearbook of Huayuan County and the achievement reference method, from 2000 to 2017, the cumulative decrease in the arable land area caused by mining in Huayuan County was 199.03 ha, with an annual loss rate of 5.88%. By determining the economic loss per unit area of crops caused by local arable land destruction as 227.29 million yuan/(ha a), it can be concluded that the cumulative production loss caused by the reduction in arable land area was 38.4519 million yuan. It should be noted that the increase of the forest land area is the result of the restoration and governance, and the governance cost investment and the generated benefits are calculated comprehensively in the restoration and governance section. Therefore, the total agriculture and forestry production loss is 38.4519 million yuan.

(3) Environmental Pollution and Health Loss

Forest land area and wood loss is as follows area loss (hm²)×natural forest volume (m³/hm²)×annual net growth rate (%)×fixed number of years (a)×standing forest stock price (yuan/m³).

Crop yield loss resulting from the arable land area is as follows: economic loss per unit area of crops (yuan/hm²)×area loss (hm²).

The relevant data sources can be on-site investigations, remote sensing image interpretation, local statistical yearbook reference, publicly published literature, publicly available monitoring and testing reports, government reports, and the like.

Loss of human health caused by reduced production. Firstly, the pathways and exceeding standards of health damage caused by pollution are identified, and the exposed population is determined. The direct influence of mining in Huayuan County on the health of human bodies is drinking water pollution and air pollution, and the indirect effect is soil pollution. The main approaches are as follows: firstly, through the accumulation of pollutants in agricultural products, they enter the human body through the food chain and accumulate, resulting in various chronic diseases; secondly, through drinking water and atmospheric pollutants, the human body generates acute and chronic poisoning reactions, or the prevalence rate of respiratory system diseases of the human body is increased, and the loss of human capital is caused.

Because the dose-response relationship of the human health loss in mining is lacking at present, the human health and human welfare loss of 4.06 yuan/t is obtained by adopting an achievement reference method, the human health loss caused by environmental pollution is estimated through the human health loss caused by products of each production unit quantity of mining enterprises, the mineral production capacity accumulated in Huayuan County within 17 years is about 2.530654 million t, resulting in a cumulative loss of approximately 2.5301 million yuan within 17 years.

(4) Protective Cost

According to the Comprehensive Statistical Report of the Bureau of Land and Resources of Huayuan County (2011-2017) and the Statistical Bulletin on National Economic and Social Development of Huayuan County (2011-2017), as of 2017, the cumulative area of land under governance in the mining area of Huayuan County (including clearing and transporting waste rocks, cleaning abandoned work sheds, completing surface soil cover, and the like) was 5192 ha. According to Supplementary Quota Standards for Land Development and Consolidation Projects in Hunan Province (Trial), and Supplementary Quota Standards for Land Development and Consolidation Projects in Hunan Province (Trial), the cost of reclaiming 1 ha of arable land is determined to be 289300 yuan/ha, and the cumulative investment in protective costs is 1501.9715 million yuan.

(5) Restoration and Governance Cost

The restoration and governance cost includes the cost of reclaiming forest land and farmland from mining sites, waste disposal sites, tailings ponds, and the like. The restoration and governance cost of the forest land and the arable land is as follows: area loss (hm²)×restoration and governance cost per unit area (yuan hm²).

In general, the reclamation of arable land mainly includes pollution detection, site cleaning, foreign soil backfilling or soil governance; the soil layer of forest and grassland reclamation is thin, and the requirement for cultivated layer is low, and the cost input is lower than that of arable land reclamation. The industrial square that will be used in the future does not need to be reclaimed. The residential area and living facilities area of workers can still be used in the future and will not be used as a reclamation area.

The accounting of land reclamation costs includes: early soil cover costs, late soil cover costs, land leveling costs, soil improvement costs, farmland facility costs, and the like.

The area of governance area can be determined based on on-site investigations, remote sensing image interpretation, land use data, and reference is made to government and enterprise restoration and governance implementation plans.

In the mines of Huayuan County, the land use/cover types are significantly changed under the conditions of “mining, disposal, land creation, and reclamation” and industrial site and village construction models. After several years of restoration and governance, some mining areas, waste disposal areas, and tailings ponds have now been reclaimed into farmland, forest land, and the like, forming a large-scale ecological restoration and governance area. From 2000 to 2017, the areas of forest land and ecological restoration and governance area have increased by 78.86 ha and 233.31 ha, respectively. According to Supplementary Quota Standards for Land Development and Consolidation Projects in Hunan Province (Trial), and Supplementary Quota Standards for Land Development and Consolidation Projects in Hunan Province (Trial), the cost of reclaiming 1 ha of arable land is determined to be 289300 yuan/ha, and the restoration and governance cost of forest land or grassland is 245100 yuan/ha. Therefore, it can be seen that the cost of restoration and governance for mining ecological restoration and environmental governance is 616.3603 million yuan.

In summary, based on five aspects of ecological service function loss (A1), agriculture and forestry production loss (A2), environmental pollution and health loss (A3), protective cost (A4), and restoration and governance cost (A5), the total ecological destruction and environmental pollution loss (S) of mines in Huayuan County, Hunan Province is evaluated to be approximately 2.214 billion yuan. After the damage evaluation results are analyzed, it is found that the restoration and governance cost (A5) is the most significant loss. Based on the results, a mining eco-environment damage report is generated.

It can be seen from the above technical solutions that, compared with the prior art, the present invention discloses and provides a mining eco-environment damage evaluation method, a mining eco-environment damage evaluation system, and a storable medium; based on the operability of an evaluation index system and with reference to a classification method of common environmental problems and an environmental pollution cost evaluation theory and method, the present invention integrates mineral resource development life cycle into the evaluation system, focuses on five aspects of ecological destruction system service function loss, agriculture and forestry production loss caused by land use change, human health loss caused by environmental pollution, ecological restoration investment for disaster and environmental governance in the development process, and cost for restoration and governance of the caused ecological destruction and environmental pollution, and establishes a large-scale open-pit mine ecological destruction and environmental pollution loss evaluation index system based on a constraint layer, a criterion layer, and an index layer, so that the evaluation range is more comprehensive; and meanwhile, the evaluation index information of the present invention is not repeated and redundant, and the comprehensiveness and operability of index selection are considered, that is, the present invention does not evaluate all indexes one by one, but emphatically selects the key evaluation indexes according to the mine ecological destruction and the environmental pollution loss caused by different types of mining modes in combination with the actual eco-environment problem, so that the evaluation accuracy is improved based on reducing the calculation amount of evaluation.

The embodiments in the specification are all described in a progressive manner, and each embodiment focuses on differences from other embodiments, and portions that are the same and similar between the embodiments may be referred to each other. Since the device disclosed in the embodiment corresponds to the method disclosed in the embodiment, the description is relatively simple, and reference may be made to the partial description of the method.

The above description of the disclosed embodiments enables those skilled in the art to implement or use the present invention. Various modifications to these embodiments will be readily apparent to those skilled in the art, and the general principles defined herein may be applied to other embodiments without departing from the spirit or scope of the present invention. Thus, the present invention is not intended to be limited to these embodiments shown herein but is to accord with the broadest scope consistent with the principles and novel features disclosed herein.

What is claimed is:

1. A mining eco-environment damage evaluation method, comprising the following steps:
S100: acquiring a data source, determining an environmental condition according to the data source, and obtaining an eco-environment influence factor according to the environmental condition;
S200: classifying and screening the data source based on the eco-environment influence factor to obtain evaluation index information of a mining eco-environment damage;
S300: constructing a mine ecological destruction and environmental pollution loss system according to the evaluation index information;
S400: establishing n loss evaluation models according to the mine ecological destruction and environmental pollution loss system; and
S500: performing loss calculation on the n loss evaluation models, and performing damage evaluation on a mining eco-environment according to a loss calculation result.

2. The mining eco-environment damage evaluation method according to claim 1, further comprising:
S600: analyzing a damage evaluation result to obtain a probability of occurrence of various environmental damage types related to different data sources; and
S700: generating a mining eco-environment damage report according to a probability result.

3. The mining eco-environment damage evaluation method according to claim 1, wherein S100 comprises:
S110: acquiring the data source, and determining the environmental condition according to the data source;
S120: judging whether the environmental condition is influenced by a mineral resource development activity or not to obtain a judgment result; and
S130: obtaining the eco-environment influence factor according to the judgment result.

4. The mining eco-environment damage evaluation method according to claim 1, wherein the evaluation index information comprises: ecological destruction system service function loss index information, agriculture and forestry production loss index information, environmental pollution and health loss index information, protective cost index information, and restoration and governance cost index information.

5. The mining eco-environment damage evaluation method according to claim 4, wherein S300 comprises:
S310: deriving different evaluation index information as a target layer, determining first native variables included in the different evaluation index information, and acquiring first derived variables associated with the first native variables, wherein the first native variables are corresponding constraint layer information;
S320: deriving the constraint layer information, and determining second derived variables associated with second native variables included in different constraint layer information, wherein the second derived variables are corresponding criterion layer information;
S330: deriving different criterion layer information, and determining third derived variables associated with third native variables included in the different criterion layer information, wherein the third derived variables are corresponding index layer information; and
S340: matching the constraint layer information, the criterion layer information, and the index layer information to generate the mine ecological destruction and environmental pollution loss system.

6. The mining eco-environment damage evaluation method according to claim 1, wherein S500 comprises:
S510: performing loss calculation according to a loss evaluation model of the n loss evaluation models to obtain a loss calculation result;
S520: analyzing physical loss measurement caused by environmental destruction according to the loss calculation result to obtain a physical loss measurement result;
S530: monetizing the physical loss measurement result to obtain a monetization result; and
S540: performing damage evaluation on the mining eco-environment according to the physical loss measurement result and the monetization result.

7. The mining eco-environment damage evaluation method according to claim 6, wherein S510 comprises:
S511: giving an n^{th} loss evaluation model, and setting component parameters influencing the n^{th} loss evaluation model;
S512: generating a corresponding loss value n (i, j) according to each component parameter n1 and n2 of each loss evaluation model, wherein i represents a combined serial number of n1 and n2, j represents s serial number of the n^{th} loss evaluation model, 1≤i≤m, and 1≤j≤n;
S514: calculating a maximum loss value of each loss evaluation model:
Optimal_n=Max((1:n,j));
S513: calculating an opportunity cost value of each loss evaluation model, wherein an opportunity cost value Cost(n) of the n^{th} loss evaluation model is calculated by:
Cost(n)=|Optimal_n−n(i,j)|;
S514: calculating a total opportunity cost value:
Z=Σⱼ₌₁ⁿCost(n); and
S515: obtaining the loss calculation result according to the total opportunity cost value.

8. A mining eco-environment damage evaluation system, comprising:
a preprocessing module, configured to acquire a data source, determine an environmental condition according to the data source, and obtain an eco-environment influence factor according to the environmental condition;
a classification module, connected to the preprocessing module and configured to classify and screen the data source based on the eco-environment influence factor to obtain evaluation index information of a mining eco-environment damage;
a construction module, connected to the classification module and configured to construct a mine ecological destruction and environmental pollution loss system according to the evaluation index information;
a processing module, connected to the construction module and configured to establish n loss evaluation models according to the mine ecological destruction and environmental pollution loss system; and
a calculation module, connected to the processing module and configured to perform loss calculation on the n loss evaluation models, and perform damage evaluation on a mining eco-environment according to a loss calculation result.

9. The mining eco-environment damage evaluation system according to claim 8, further comprising:
an analysis module, connected to the calculation module and configured to analyze a damage evaluation result to obtain a probability of occurrence of various environmental damage types related to different data sources; and
an output module, connected to the analysis module and configured to generate a mining eco-environment damage report according to a probability result.

10. A computer readable storage medium storing computer readable instructions, wherein the computer readable instructions, when executed by a processor, implement steps of the mining eco-environment damage evaluation method according to claim 1.

11. The computer readable storage medium according to claim 10, wherein the mining eco-environment damage evaluation method further comprises:
S600: analyzing a damage evaluation result to obtain a probability of occurrence of various environmental damage types related to different data sources; and
S700: generating a mining eco-environment damage report according to a probability result.

12. The computer readable storage medium according to claim 10, wherein in the mining eco-environment damage evaluation method, S100 comprises:
S110: acquiring the data source, and determining the environmental condition according to the data source;
S120: judging whether the environmental condition is influenced by a mineral resource development activity or not to obtain a judgment result; and
S130: obtaining the eco-environment influence factor according to the judgment result.

13. The computer readable storage medium according to claim 10, wherein in the mining eco-environment damage evaluation method, the evaluation index information comprises: ecological destruction system service function loss index information, agriculture and forestry production loss index information, environmental pollution and health loss index information, protective cost index information, and restoration and governance cost index information.

14. The computer readable storage medium according to claim 13, wherein in the mining eco-environment damage evaluation method, S300 comprises:
S310: deriving different evaluation index information as a target layer, determining first native variables included in the different evaluation index information, and acquiring first derived variables associated with the first native variables, wherein the first native variables are corresponding constraint layer information;
S320: deriving the constraint layer information, and determining second derived variables associated with second native variables included in different constraint layer information, wherein the second derived variables are corresponding criterion layer information;
S330: deriving different criterion layer information, and determining third derived variables associated with third native variables included in the different criterion layer information, wherein the third derived variables are corresponding index layer information; and
S340: matching the constraint layer information, the criterion layer information, and the index layer information to generate the mine ecological destruction and environmental pollution loss system.
